(19) United States
(12) Patent Application Publication
(10) Pub. No.: US 2004/0247804 A1
(43) Pub. Date: Dec. 9, 2004

(54) Ink-jet recording medium and method of improving moisture resistance of same

(75) Inventors: Jae-hwan Kim, Gyeonggi-do (KR); Taek-yong Jung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/859,357

(22) Filed: Jun. 3, 2004

(30) Foreign Application Priority Data
Jun. 3, 2003 (KR) 2003-35599

(51) Int. Cl. B41M 5/00

(52) U.S. Cl. 428/32.36

(57) ABSTRACT

An ink-jet recording medium including: a substrate; and an ink receiving layer coated on a surface of the substrate and including an inorganic filler, a polyvinyl alcohol, a cationic core-shell latex with a glass transition temperature (Tg) of at least 50° C., and a zirconium compound.

### CROSS-REFERENCE TO RELATED APPLICATION

This application claims priority from Korean Patent Application No. 2003-35599, filed on Jun. 3, 2003, in the Korean Intellectual Property Office, the disclosure of which is incorporated herein by reference.

### BACKGROUND OF THE INVENTION

1. Field of the Invention

The present invention relates to a recording medium, and more particularly, to an ink-jet recording medium including an ink receiving layer coated on a surface of a substrate.

Ink-jet printers have been widely used because they can provide a fast output speed, low cost, and high-resolution images.

2. Description of Related Art

Various recording media such as a plain paper, a specially coated paper, and special films have been used in ink-jet printers. When ink-jet recording media include a hydrophobic substrate made of polyester such as polyethylene terephthalate, and cellulose acetate, a hydrophilic material is coated on the hydrophobic substrate to promote ink fixation on the recording media. Here, the coating layer including the hydrophilic material is designated as an ink receiving layer.

Such ink-jet recording media including a hydrophobic substrate and an ink receiving layer have been used as presentation means through overhead projectors, external wall decorations, designs, advertisements, and the like.

Current ink-jet recording can form an image having an image quality comparable to a silver salt photograph, which is the ultimate objective of hard copy technology.

Illustrative examples of ink-jet recording media are as follows.

U.S. Pat. No. 5,866,268 and Japanese Patent Laid-Open Publication Nos. 55-144172 and 62-268682 each disclose an ink-jet recording medium with improved ink absorption speed and capacity using a hydrophilic binder resin such as a cellulose derivative and a polyvinyl alcohol as a binder. However, there arises a problem in that the recording medium has poor water resistance.

Japanese Patent Laid-Open Publication Nos. 59-198186 and 56-84992 each disclose an ink-jet recording medium including a coating layer made of an organic acid salt of polyethyleneimine. Even though the recording medium has excellent water resistance, heat and light resistance is poor, thereby causing yellowing upon exposure to ultraviolet light.

Recently, there has been an increasing interest in a recording medium containing alumina that can provide advantages such as excellent dye fixing property and glossy image creation over a conventional recording medium. U.S. Pat. Nos. 4,879,166 and 5,104,730 and Japanese Patent Laid-Open Publication Nos. 2-276670, 4-37576, and 5-32037 each disclose a recording medium containing alumina hydrate with a boehmite structure.

In addition, an ink-jet recording paper using a zirconium-containing compound is also disclosed. Japanese Patent Laid-Open Publication Nos. 55-53591, 55-150396, 56-86789, 58-89391, and 58-94491 each disclose an ink-jet recording sheet containing a polyvalent metal salt that is combined with a water soluble dye to form a water insoluble salt.

Japanese Patent Laid-Open Publication Nos. 60-67190, 61-10584, and 61-57379 each disclose an ink-jet recording sheet containing a cationic polymer and a water soluble polyvalent metal salt.

Japanese Patent Laid-Open Publication No. 4-7189 discloses an ink-jet recording medium using a porous pigment and a zirconium salt.

European Patent No. 754,560 discloses an ink-jet recording sheet using a water-soluble binder, a pigment, a zirconium compound, and a cationic polymer.

However, the above patent documents are silent about advantages provided in the present invention, in particular, an improvement in moisture resistance at high temperature.

### BRIEF SUMMARY

The present invention provides an ink-jet recording medium comprising an ink receiving layer with excellent water resistance and ink absorptivity, in addition to excellent moisture resistance at high temperature.

According to an aspect of the present invention, there is provided an ink-jet recording medium comprising: a substrate; and an ink receiving layer coated on a surface of the substrate and including an inorganic filler, a polyvinyl alcohol, a cationic core-shell latex, and a zirconium compound.

According to another aspect of the present invention, there is provided a method of improving a moisture resistance of an ink-jet recording medium, including: coating a surface of a substrate with an ink receiving layer including an inorganic filler, a polyvinyl alcohol, a cationic core-shell latex with a glass transition temperature (Tg) of at least 50° C., and a zirconium compound.

According to another aspect of the present invention, there is provided a method of improving a moisture resistance of an ink-jet recording medium, including: forming as ink receiving layer including an inorganic filler, a polyvinyl alcohol, a cationic core-shell latex with a glass transition temperature (Tg) of at least 50° C., and a zirconium compound; and coating a surface of a substrate with the ink receiving layer.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a sectional view of an ink-jet recording medium according to an embodiment of the present invention.

### DETAILED DESCRIPTION OF EMBODIMENT

Reference will now be made in detail to an embodiment of the present invention, an example of which is illustrated in the accompanying drawing. The embodiment is described below in order to explain the present invention by referring to the figure.

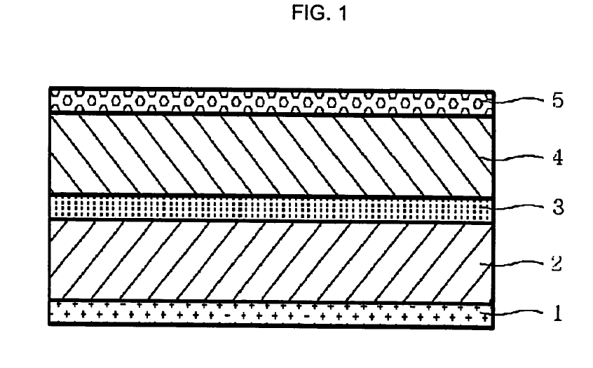

FIG. 1 is a sectional view of an ink-jet recording medium according to an embodiment of the present invention. Referring to FIG. 1, an ink-jet recording medium includes a substrate 2 and an ink receiving layer 4. The ink-jet recording medium is also shown to include an undercoating layer 3 interposed between the ink receiving layer 4 and the substrate 2, a back coating layer 1 formed on a lower surface of the substrate 2, and a protective layer 5 having ink permeability formed on an upper surface of the ink receiving layer 4.

To manufacture an ink-jet recording medium according to the present embodiment, a composition for the ink receiving layer 4 is first prepared by dissolving or dispersing an inorganic filler, a polyvinyl alcohol, a cationic latex having a core-shell structure, and a zirconium compound, in a solvent.

The inorganic filler may be calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica, or alumina. Applicants have determined that alumina in particular performs well. In particular, one or more alumina represented by Formula 2 have been determined to perform well:

Al₂O₃₋ₚ(OH)₂ₚ.qH₂O Formula 2

wherein p is an integer from 0 to 3, and q is a rational number from 0 to 10, and especially, a rational number from 0 to 5. The types of alumina include alumina having boehimite or an amorphous structure, which are identified by an x-ray diffraction.

Since alumina has a positive charge, it has advantages such as good fixation of a dye in an ink into the ink receiving layer, good transparency, a high print density, and good color creation. Also, since alumina forms a porous layer, it can impart good ink absorptivity to the ink receiving layer. While a resin-type ink-jet layer composed of a hydrophilic polymer provides poor water resistance, the porous layer formation technology using alumima, like in the present embodiment, enables the formation of an ink receiving layer mainly made of a pigment, thereby enhancing water resistance. In addition, alumina provides good surface characteristics such as absence of film sticking that may be caused by use of only a binder.

Alumina may be used in the form of powders. In some cases, a sol that contains alumina powders may be used. When a pigment is present in the form of a sol, if the size of particles in the sol is too small, ink absorptivity may decrease. On the other hand, if the size of particles in the sol is too large, the transparency of a recording medium may be lowered. In this regard, alumina with a particle diameter of 20 to 200 nm is generally used.

If the content of the inorganic filler in the composition for the ink receiving layer is excessively low or high, film sticking or low ink absorptivity as described above may occur. In this regard, it is important to appropriately adjust the content of the inorganic filler.

The ink receiving layer may contain additive pigments except alumina, for example, an inorganic pigment such as calcium carbonate, kaolin, talc, calcium sulfate, barium sulfate, titanium oxide, zinc oxide, zinc carbonate, aluminum silicate, silicic acid, sodium silicate, magnesium silicate, calcium silicate, and silica; an organic pigment such as a plastic pigment and an urea resin pigment; or a mixture thereof in an amount such that the advantages of the present embodiment are not adversely affected. These additional pigments may be used in an amount of 20 parts by weight or less, and especially 0.0001-15 parts by weight based on 100 parts by weight of alumina used as the inorganic filler.

The polyvinyl alcohol in the composition for the ink receiving layer serves to enhance printability and adhesive strength for a pigment, and thus, is used as a main binder.

The polyvinyl alcohol that is usable has the degree of polymerization of 1,000 or more, and especially, 1,500 to 5,000, and the degree of saponification of 70 to 100%, and especially 80 to 99.5%.

If the content of the polyvinyl alcohol is too low, the polyvinyl alcohol may not serve as a binder, thereby lowering adhesion to the substrate. Furthermore, the relative ratio of other components such as a pigment may increase, thereby forming a crack in the ink receiving layer. On the other hand, if the content of the polyvinyl alcohol is too high, a binder may occupy most of the ink receiving layer, which renders ink absorption and high-speed ink drying difficult.

In this regard, the polyvinyl alcohol, which is a binder in the composition for the ink receiving layer, is preferably used in an amount of 5 to 100 parts by weight, based on 100 parts by weight of the inorganic filler.

The composition for the ink receiving layer may further include a hydrophilic polymer, except the polyvinyl alcohol used as a binder, for example, polyvinyl pyrrolidone, methylcellulose, hydroxypropyl methylcellulose, gelatin, starch, polyethylene oxide, acrylic polymer, polyester, or polyurethane. The hydrophilic polymer may be used in an amount of 50 parts by weight or less, and especially 0 to 20 parts by weight, based on 100 parts by weight of the polyvinyl alcohol.

The cationic core-shell latex in the composition for the ink receiving layer may be any one having a polymer unit with a cationic group. For example, a cationic latex having a core-shell structure and represented by Formula 1 below may be used:

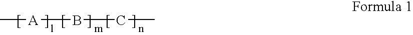

wherein -A- is a copolymer unit of copolymerizable monomers with a tertiary amino group or a quaternary ammonium group; -B- is a copolymer unit of copolymerizable monomers with at least two unsaturated double bonds; -C- is a copolymer unit of copolymerizable monomers with unsaturated double bonds that remain unreacted on -A- and -B-, I is 10 to 99 mole, m is 0 to 10 mole (in particular, 0.0001 to 10 mole), and n is 0 to 90 mole (in particular, 0.0001 to 90 mole), provided that m and n are not 0 mole at the same time.

Examples of the cationic core-shell latex include styrene-acryl based cationic latex.

Generally, a dye contained in color ink for an ink-jet printer is a direct dye or an acidic dye having an anionic carboxyl or sulfonic acid group. Therefore, the dye is fixed through an ionic bond with a cationic material such as the above latex, thereby increasing the water resistance and fixing property of an image created by the dye.

There may be a difference between cores and shells of the cationic core-shell latex with respect to glass transition temperature (Tg), gel content, molecular weight, or the content of cationic functional groups. There may be a difference in the content of cationic functional groups between cores and shells of the cationic core-shell latex. In this case, the cationic core-shell latex has a core-shell structure comprised of hard cores, which have no cationic functional groups and cannot be swelled, and soft shells, which have acid swellable cationic functional groups. Such a core-shell latex can serve as both a filler and a binder, and thus, it is more favorable for a composition requiring both a filler and a binder.

Generally, a cationic latex has a Tg of −30 to 60° C. However, a cationic latex with such a low Tg may provide a dye fixing effect but poor moisture resistance at high temperature. The cationic core-shell latex of the present embodiment has Tg of 50 to 150° C., preferably 60 to 140° C. Also, a cationic latex with high Tg generally maintains the high porosity of a coating layer. The cationic core-shell latex of the present embodiment has a particle diameter of 20 to 200 nm. The particle diameter can be obtained by adjusting the content of a surfactant, a radical initiator, etc., during latex preparation.

If the content of the cationic core-shell latex in the composition for the ink receiving layer is too low, a sufficient addition effect may not be obtained. On the other hand, if it is too high, the total content of fillers may increase excessively, thereby causing crack formation in the ink receiving layer or adversely affecting ink-jet printability. In this regard, the cationic core-shell latex may be used in an amount of 0.5 to 50 parts by weight, based on 100 parts by weight of the inorganic filler.

There are no particular limitations on the zirconium compound in the composition for the ink receiving layer provided that it is a zirconium-containing compound.

The zirconium compound may be water soluble or insoluble provided that it can be uniformly distributed in the composition for the ink receiving layer. Examples of the zirconium compound include zirconium difluoride, zirconium trifluoride, zirconium tetrafluoride, zirconium dichloride, zirconium trichloride, zirconium tetrachloride, zirconium oxychloride (zirconyl chloride), zirconium dibromide, zirconium tribromide, zirconium tetrabromide, zirconium triiodide, zirconium tetraiodide, zirconium sulfide, zirconium sulfate, zirconium p-toluenesulfonate, zirconyl sulfate, sodium zirconyl sulfate, acidic zirconyl sulfate trihydrate, potassium zirconyl sulfate, zirconium nitrate, zirconyl nitrate, zirconium phosphate, zirconium carbonate, ammonium zirconyl carbonate, zirconium acetate, zirconyl acetate, ammonium zirconyl acetate, zirconyl phosphate, zirconium lactate, and zirconyl citrate.

Generally, a recording medium including a porous ink receiving layer made of mainly a pigment such as alumina has excellent water resistance. However, it may be adversely affected when immersed in water for a long time or is exposed to a high temperature and high humidity environment. Since the zirconium compound of the present embodiment serves as a cross-linking agent, a moisture resistance in a high temperature and high humidity environment can be enhanced, together with additional water resistance enhancement.

In addition to being a cross-linking agent, the zirconium compound serves to provide dye fixation due to the presence of polyvalent zirconium metal, thereby creating a synergistic effect with the cationic core-shell latex for dye fixation. When the zirconium compound is acidic, it participates in acid swelling of shells of the cationic core-shell latex. At this time, the swelled shells are entangled at the time of drying a coating layer, thereby enhancing the water resistance of the coating layer. Generally, an excessive increase in water resistance by a cross-linkage may reduce ink absorptivity or moisture resistance. However, the structural entanglement according to the present invention does not affect moisture resistance.

That is, concurrent use of the core-shell latex with a high Tg and the zirconium compound according to the present embodiment provides a recording medium with excellent moisture resistance such as less ink blurring even in a high temperature and high humidity environment, together with excellent water resistance and ink fixing property.

If the content of the zirconium compound in the composition for the ink receiving layer is too low, a sufficient addition effect may not be obtained. On the other hand, if it is too high, ink absorptivity may decrease, thereby adversely affecting ink-jet printability. In this regard, the zirconium compound may be used in an amount of 0.05 to 25 parts by weight, based on 100 parts by weight of the inorganic filler.

There are no limitations on the solvent to be used in the composition for the ink receiving layer. Considering environmental contamination and workability, water is mainly used. Ketones, glycol ethers, alcohols, methyl cellosolves, ethyl cellosolves, dimethylformamides, or dimethylsulfoxides may also be used. Non-limiting examples of the usable ketones include acetone and methylethylketone, examples of the glycol ethers include diethylene glycol and diethylene glycol monobutylether, and examples of the alcohols include methanol, ethanol, butanol, and isopropanol.

The solvent may be used in an amount so that the content of solids in the ink receiving layer is in a range of 5 to 40 parts by weight, based on 100 parts by weight of the composition for the ink receiving layer. Here, the content of the solids of the ink receiving layer is the sum of the contents of the inorganic filler, the polyvinyl alcohol, the cationic core-shell latex, and the zirconium compound.

If the content of the solids is too low, viscosity may decrease excessively and drying of a coating layer may be retarded. On the other hand, if it is too high, surface characteristics may be deteriorated due to excessively high viscosity.

An organic solvent such as alcohol, except water, may be used in an amount of about 5 to about 50 parts by weight, based on the total content (100 parts by weight) of the solvent. If the content of the organic solvent is too small, drying characteristics may worsen. If it is too high, solubility problems may occur and a material cost may increase.

The composition for the ink receiving layer may further include other additives to supplement physical properties of the layer. As an example, there may be used a cross-linking agent serving to increase water resistance and surface strength by a cross-linkage between a binder component and an inorganic filler component. If the content of the cross-linking agent is too low, a sufficient addition effect may not be obtained. On the other hand, if it is too high, excessive cross-linkages may occur, thereby decreasing ink absorptivity. In this regard, the cross-linking agent may be used in an amount of 0.01 to 10 parts by weight, based on 100 parts by weight of the solids in the ink receiving layer.

The cross-linking agent may be oxazoline, isocyanates, epoxides, aziridine, melamin-formaldehyde, dialdehydes, boron compound, or a mixture thereof. The isocyanates may be tolylene diisocyanate (TDI) adduct, the epoxides may be epichlorohydrin, the dialdehyde may be glyoxal or glutaric dialdehyde, and the boron compound may be a boric acid or Borax. In addition, a fixing agent, a dye, a fluorescent dye, a light dispersing agent, a pH adjustor, an antioxidant, an antifoaming agent, a leveling agent, a lubricant, a curling prevention agent, a surface adjustor, or a wettability enhancer may be used as the additives. The fluorescent dye increases visible whiteness (apparent whiteness).

If the content of the additives is too low, a sufficient addition effect may not be obtained. If it is too high, the printability and coating characteristics of a recording medium may be lowered. In this regard, the additives in the composition for the ink receiving layer may be used in the total amount of 0.015 to 15 parts by weight, based on 100 parts by weight of the solids in the ink receiving layer.

The composition for the ink receiving layer is coated on a surface of the substrate and dried to form an inkjet recording medium including the ink receiving layer. The drying may be carried out at a temperature of 50 to 130° C. When the composition for the ink receiving layer includes a cross-linking agent, a thermal cross-linkage by the cross-linking agent occurs during the drying process. In this regard, if the drying temperature is less than 50° C., a cross-linkage may decrease. If it exceeds 130° C., yellowing may occur.

While if the thickness of the ink receiving layer thus formed is too thin, ink absorptivity may decrease, if it is too thick, a production cost may increase and drying of a coating layer may be retarded. In this regard, the ink receiving layer may have a thickness of about 8 to about 80 μm.

The substrate for an ink-jet recording medium of the present invention may be one selected from the group consisting of a transparent or translucent film made of one selected from polyesters, polycarbonates, cellulose-acetates, and polyethylenes; a polyethylene or polypropylene coated paper; a one- or two-side art paper; a cast coated paper; a synthetic paper; a resin-coated paper; and a baryta paper. The substrate has a thickness of 70 to 350 μm to provide easy handling property and prevent bending that may be caused upon formation of a coating layer thereon.

Turning to FIG. 1, an ink-jet recording medium of the present embodiment may further include the undercoating layer 3 interposed between the substrate 2 and the ink receiving layer 4 to enhance adhesive strength therebetween. The undercoating layer 3 may be made of a two-component primer of polyol and polyisocyanate or a one-component primer selected from acrylics, urethanes, acryl-urethanes, and vinyls. The undercoating layer is formed to a thickness of 0.2 to 2.0 μm, preferably about 1 μm so that the content of the one or two-component primer is in a range of 0.2 to 2 g/m².

The protective layer 5 may be formed on an upper surface of the ink receiving layer to protect the underlying layers and the back coating layer 1 may be formed on a lower surface of the substrate 2.

The protective layer 5 may be made of celluloses, polyethylene oxides, or the above compounds for the cross-linking agent that can provide excellent ink permeability and good surface strength after being cured. The protective layer 5 has a thickness of about 0.5 to 3 μm.

The back coating layer 1 serves to enhance a continuous paper feeding property and to prevent a curling phenomenon. For this, the back coating layer 1 may be made of polyvinyl alcohol used as a binder for the ink receiving layer, polyvinyl pyrrolidone, methylcellulose, hydroxypropy Imethylcellulose, gelatin, polyethylene oxide, acrylic polymer, polyesters, polyurethanes, or the above-described compounds for the cross-linking agent such as oxazoline, isocyanate, epoxide, aziridine, mellamin-formaldehyde, dialdehyde, and boron compound. The back coating layer 1 has a thickness of 0.5 to 4 μm.

Hereinafter, the present embodiment will be described by the following non-limiting examples.

### EXAMPLE 1

A composition for an ink receiving layer was prepared according to the following formulation.

| | Content |
|---|---|
| Components for ink receiving layer | (parts by weight) |
| Alumina (ALUMINIUMOXID C, Degussa, Germany) | 87.5 |
| Polyvinyl alcohol (PVA 224E, Kuraray, Japan) | 7.0 |
| Cationic core-shell latex (TruDot DPX-8015-87, | 1.8 |
| Westvaco, America) | |
| Zirconium oxychloride (Junsei, Japan) | 2.1 |
| Leveling agent (Flow 425, Tego, Germany) | 1.0 |
| Fluorescent dye (SW5274F, Samone Corp.) | 0.5 |
| Boric acid (Samchun Co., Ltd.) | 0.1 |
| Mixed solvent | 400 |
| (distilled water:ethanol: | |
| dimethylformamide = 75:10:15, by weight) | |

The composition for the ink receiving layer was coated on an upper surface of a 200 g/m² basis weight, gelatin-treated resin-coated paper (also called a baryta paper) with a bar coater and dried at 110° C. for 3 minutes to manufacture an ink-jet recording medium including the ink receiving layer with a thickness of about 35 μm.

### EXAMPLE 2

An ink-jet recording medium was manufactured in the same manner as in Example 1 except that a composition for an ink receiving layer was prepared according to the following formulation.

| | Content |
|---|---|
| | (parts |
| Components for ink receiving layer | by weight) |
| Alumina sol (PG 003, Cabot, America) | 85.0 |
| Polyvinyl alcohol (PVA 117, Kuraray, Japan) | 10.0 |
| Cationic core-shell latex (TruDot DPX-8087-06, Westvaco, | 1.3 |
| America) | |
| Zirconium oxychloride (Junsei, Japan) | 1.5 |
| Glyoxal (Samchun Co., Ltd.) | 0.65 |
| Leveling agent (Flow 425, Tego, Germany) | 1.0 |
| Fluorescent dye (SW5274F, Samone Corp.) | 0.5 |
| Borax (Samchun Co., Ltd.) | 0.05 |
| Mixed solvent | 400 |
| (distilled water:ethanol: | |
| dimethylformamide = 70:10:20, by weight) | |

### EXAMPLE 3

An ink-jet recording medium was manufactured in the same manner as in Example 1 except that a composition for an ink receiving layer was prepared according to the following formulation.

| | Content |
|---|---|
| Components for ink receiving layer | (parts by weight) |
| Alumina sol (SS 30, HANA Chemicals) | 76.9 |
| Alumina (ALUMINIUMOXID C, Degussa, Germany) | 8.5 |
| Polyvinyl alcohol (PVA P-17, | 8.0 |
| Dongyang Chemical. Co.) | |
| Cationic core-shell latex (TruDot DPX-8015-87, | 1.5 |
| Westvaco, America) | |
| Zirconyl nitrate (Aldrich, America) | 3.5 |
| Leveling agent (Flow 425, Tego, Germany) | 1.0 |
| Fluorescent dye (SW5274F, Samone Corp.) | 0.5 |
| Boric acid (Samchun Co., Ltd.) | 0.1 |
| Mixed solvent | 400 |
| (distilled water:ethanol:dimethylformamide: | |
| dimethylsulfoxide = 70:10:15:5, by weight) | |

### COMPARATIVE EXAMPLE 1

An ink-jet recording medium was manufactured in the same manner as in Example 1 except that a composition for an ink receiving layer was prepared according to the following formulation.

| | Content |
|---|---|
| Components for ink receiving layer | (parts by weight) |
| Alumina (ALUMINIUMOXID C, Degussa, Germany) | 87.5 |
| Polyvinyl alcohol (PVA 224E, Kuraray, Japan) | 7.0 |
| Cationic latex (TruDot DPX-8246-34, | 1.8 |
| Westvaco, America) | |
| Zirconium oxychloride (Junsei, Japan) | 2.1 |
| Leveling agent (Flow 425, Tego, Germany) | 1.0 |
| Fluorescent dye (SW5274F, Samone Corp.) | 0.5 |
| Boric acid (Samchun Co., Ltd.) | 0.1 |
| Mixed solvent | 400 |
| (distilled water:ethanol: | |
| dimethylformamide = 75:10:15, by weight) | |

### COMPARATIVE EXAMPLE 2

An ink-jet recording medium was manufactured in the same manner as in Example 1 except that a composition for an ink receiving layer was prepared according to the following formulation.

| Components for ink receiving layer | Content (parts by weight) |
|---|---|
| Alumina sol (PG 003, Cabot, America) | 85.0 |
| Polyvinyl alcohol (PVA 117, Kuraray, Japan) | 10.0 |
| Hydroxypropylmethylcellulose (60SH-50, | 1.3 |
| Shin Etsu, Japan) | |
| Zirconium oxychloride (Junsei, Japan) | 1.5 |
| Glyoxal (Samchun Co., Ltd.) | 0.65 |
| Leveling agent (Flow 425, Tego, Germany) | 1.0 |
| Fluorescent dye (SW5274F, Samone Corp.) | 0.5 |
| Borax (Samchun Co., Ltd.) | 0.05 |
| Mixed solvent (distilled water: | |
| ethanol = 80:20, by weight) | 400 |

### COMPARATIVE EXAMPLE 3

An ink-jet recording medium was manufactured in the same manner as in Example 1 except that a composition for an ink receiving layer was prepared according to the following formulation.

| | Content |
|---|---|
| Components for ink receiving layer | (parts by weight) |
| Alumina sol (SS 30, HANA Chemicals) | 79.9 |
| Alumina (ALUMINIUMOXID C, Degussa, Germany) | 8.5 |
| Polyvinyl alcohol (PVA P-17, | 8.5 |
| Dongyang Chemical. Co.) | |
| Cationic core-shell latex (TruDot DPX-8015-87, | 1.5 |
| Westvaco, America) | |
| Leveling agent (Flow 425, Tego, Germany) | 1.0 |
| Fluorescent dye (SW5274F, Samone Corp.) | 0.5 |
| Boric acid (Samchun Co., Ltd.) | 0.1 |
| Mixed solvent | 400 |
| (distilled water:ethanol:dimethylformamide: | |
| dimethylsulfoxide = 70:10:15:5, by weight) | |

Image printing was performed on the ink-jet recording media according to Examples 1 through 3 and Comparative Examples 1 through 3 using a color ink-jet printer (MJC-1130i, Samsung, Korea).

The images printed on the ink-jet recording media according to Examples 1 through 3 and Comparative Examples 1 through 3 were tested for ink absorptivity, color image clarity (presence or absence of blurring), long- and short-term water resistance, and moisture resistance according to the following methods. The results are presented in Table 1 below.

Evaluation Methods

### A) Ink Absorptivity

Standard images (mainly composite black images) were printed on each of A4-sized samples of Examples 1 through 3 and Comparative Examples 1 through 3 using a MJC-1130i printer and plain papers were placed thereon. The plain papers were pressed by a 5 kg iron mass for 10 seconds and the ink absorptivity was evaluated by observing the degree of ink absorption into the plain papers.

### B) Bleeding

Standard images (mainly composite black images) were printed on each of A4-sized samples of Examples 1 through 3 and Comparative Examples 1 through 3 using a MJC-1130i printer and the samples were left for 24 hours. The image clarity was evaluated by observing vividness of standard lines.

### C) Water Resistance

Samples (2.5 cm×5.0 cm) of Examples 1 through 3 and Comparative Example 1 through 3 were placed in a water bath set at room temperature (25° C.) and stirred for 30 minutes and 24 hours. The water resistance was evaluated by observing a surface image change or the degree of destruction of an ink receiving layer.

### D) Moisture Resistance

Standard color images were printed on each of A4-sized samples of Examples 1 through 3 and Comparative Examples 1 through 3 using a MJC-1130i printer and the samples were left under the conditions of 60° C., RH 95% for 24 hours. The moisture resistance was evaluated by observing image blurring.

TABLE 1

| Section | | Example 1 | Example 2 | Example 3 | Comp. 1 | Comp. 2 | Comp. 3 |
|---|---|---|---|---|---|---|---|
| Ink absorptivity | | ◯ | ◯ | ◯ | ◯ | ◯ | ◯ |
| Vividness (bleeding) | | ◯ | ◯ | ◯ | ◯ | Δ | ◯ |
| Water resistance | 30 min | ◯ | ◯ | ◯ | ◯ | • | Δ |
| | 24 hr | ◯ | ◯ | ◯ | Δ | Δ | X |
| Moisture resistance | | ◯ | ◯ | ◯ | Δ | X | Δ |

Comp.: Comparative Example
◯: Excellent,
•: Good,
Δ: Poor,
X: Very poor

As shown in Table 1 above, the inkjet recording media of Examples 1 through 3 exhibited excellent water and moisture resistance, in addition to excellent ink absorption capacity and speed, due to the ink receiving layers containing a cationic core-shell latex and a zirconium compound.

In contrast, the ink-jet recording medium of Comparative Example 1 containing a cationic latex with low Tg (−20.9° C.) having no a core-shell structure and a zirconium compound exhibited poor water and moisture resistance in a high temperature and high humidity environment. The ink-jet recording medium of Comparative Example 2 having no cationic latex exhibited very poor moisture resistance in a high temperature and high humidity environment and poor image clarity. With respect to the ink-jet recording medium of Comparative Example 3, even though a cationic core-shell latex was used, due to the absence of a zirconium compound, water resistance became worse. Accordingly, moisture resistance was slightly lowered.

As is apparent from the above descriptions, an ink-jet recording medium according to the disclosed embodiment of the present invention includes an ink receiving layer that contains both a cationic core-shell latex and a zirconium compound. Therefore, water resistance, in particular, moisture resistance in a high temperature and high humidity environment is excellent, in addition to good ink absorptivity.

Although an embodiment of the present invention have been shown and described, the present invention is not limited to the described embodiment. Instead, it would be appreciated by those skilled in the art that changes may be made in the embodiment without departing from the principles and spirit of the invention, the scope of which is defined by the claims and their equivalents.

What is claimed is:

1. An ink-jet recording medium comprising:
a substrate; and
an ink receiving layer coated on a surface of the substrate and including an inorganic filler, a polyvinyl alcohol, a cationic core-shell latex with a glass transition temperature (Tg) of at least 50° C., and a zirconium compound.

2. The ink-jet recording medium of claim 1, wherein the substrate is selected from the group consisting of a transparent or translucent film made of one selected from the group consisting of polyesters, polycarbonates, cellulose-acetates, and polyethylenes; a one-side or two-side polyethylene or polypropylene coated paper; a one-side or two-side art paper; a cast coated paper; a synthetic paper; a resin-coated paper; and a baryta paper.

3. The ink-jet recording medium of claim 1, wherein the substrate has a thickness of 70 to 350 μm.

4. The ink-jet recording medium of claim 1, wherein the polyvinyl alcohol is 5 to 100 parts by weight, the cationic core-shell latex is 0.5 to 50 parts by weight, and the zirconium compound is 0.05 to 25 parts by weight, based on 100 parts by weight of the inorganic filler.

5. The ink-jet recording medium of claim 1, wherein the ink receiving layer includes an additive to supplement physical properties of the ink receiving layer.

6. The ink-jet recording medium of claim 5, wherein the additive is 0.015 to 15 parts by weight, based on 100 parts by weight of solids in the ink receiving layer.

7. The ink-jet recording medium of claim 5, wherein the additive is a cross-linking agent which increases water resistance and surface strength by a cross-linkage between a binder component and an inorganic filler component.

8. The ink-jet recording medium of claim 7, wherein the cross-linking agent is one of the group consisting of oxazoline, isocyanates, epoxides, aziridine, melamine-formaldehyde, dialdehydes, boron compound, and a mixture thereof.

9. The ink-jet recording medium of claim 5, wherein the additive is one of a fixing agent, a dye, a fluorescent dye, a light dispersing agent, a pH adjustor, an antioxidant, an antifoaming agent, a leveling agent, a lubricant, a curling prevention agent, a surface adjustor, and a wettability enhancer.

10. The ink-jet recording medium of claim 1, wherein the cationic core-shell latex is at least one group of the compound represented by Formula 1 below: 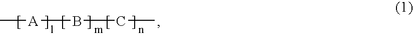
wherein -A- is a copolymer unit of copolymerizable monomers with a tertiary amino group or a quaternary ammonium group; -B- is a copolymer unit of copolymerizable monomers with at least two unsaturated double bonds; -C- is a copolymer unit of copolymerizable monomers with unsaturated double bonds that remain unreacted on -A- and -B-, I is 10 to 99 mole, m is 0 to 10 mole, and n is 0 to 90 mole, and m and n are not 0 mole.

11. The ink-jet recording medium of claim 1, wherein the cationic core-shell latex is a styrene-acryl based cationic latex.

12. The ink-jet recording medium of claim 11, wherein the cationic core-shell latex has a Tg of 50 to 150° C.

13. The ink-jet recording medium of claim 12, wherein the Tg is between 60 to 140° C.

14. The ink-jet recording medium of claim 1, has a particle diameter of 20 to 200 nm.

15. The ink-jet recording medium of claim 1, wherein the inorganic filler is at least one selected from the group consisting of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica, and alumina.

16. The ink-jet recording medium of claim 1, wherein the inorganic filler is at least one group of alumina represented by Formula 2 below:
Al₂O₃₋ₚ(OH)₂ₚ.qH₂O (2),
wherein p is an integer from 0 to 3 and q is a rational number from 0 to 10.

17. The ink-jet recording medium of claim 16, wherein q is a rational number between 0 and 5.

18. The ink-jet recording medium of claim 16, wherein the alumina has a particle diameter of between 20 and 200 nm.

19. The ink-jet recording medium of claim 1, wherein the zirconium compound is one ore more selected from the group consisting of zirconium difluoride, zirconium trifluoride, zirconium tetrafluoride, zirconium dichloride, zirconium trichloride, zirconium tetrachloride, zirconium oxychloride (zirconyl chloride), zirconium dibromide, zirconium tribromide, zirconium tetrabromide, zirconium triiodide, zirconium tetraiodide, zirconium sulfide, zirconium sulfate, zirconium p-toluenesulfonate, zirconyl sulfate, sodium zirconyl sulfate, acidic zirconyl sulfate trihydrate, potassium zirconyl sulfate, zirconium nitrate, zirconyl nitrate, zirconium phosphate, zirconium carbonate, ammonium zirconyl carbonate, zirconium acetate, zirconyl acetate, ammonium zirconyl acetate, zirconyl phosphate, zirconium lactate, and zirconyl citrate.

20. The ink-jet recording medium of claim 11, wherein the Tg of the core-shell latex is high.

21. The ink-jet recording medium of claim 1, wherein the ink receiving layer has a thickness of about 8 to 80 μm.

22. The ink-jet recording medium of claim 1, further comprising an undercoating layer interposed between the substrate and the ink receiving layer.

23. The ink-jet recording medium of claim 22, wherein the undercoating layer is one of a two-component primer of polyol and polyisocyanate and a one-component primer selected from the group consisting of acrylics, urethanes, acryl-urethanes, and vinyls.

24. The ink-jet recording medium of claim 22, wherein the undercoating layer has a thickness of between 0.2 to 2.0 μm.

25. The ink-jet recording medium of claim 24, wherein the thickness is about 1 μm and the content of the one- or two-component primer is in a range of 0.2 to 2 g/m².

1426. The ink-jet recording medium of claim 1, further comprising a protective layer formed on an upper surface of the ink receiving layer.

27. The ink-jet recording medium of claim 26, wherein the protective layer is one selected from the group consisting of celluloses, polyethylene oxides, and a cross-linking agent.

28. The ink-jet recording medium of claim 26, wherein the protective layer has a thickness of about 0.5 to 3 μm.

29. The ink-jet recording medium of claim 1, further comprising a back coating layer formed on a surface of the substrate which does not bear the ink receiving layer.

30. The ink-jet recording medium of claim 29, wherein the back coating layer one of enhances a continuous paper feeding property of the medium and prevents curling of the medium.

31. The ink-jet recording medium of claim 30, wherein the back coating layer includes at least one of polyvinyl alcohol, polyvinyl pyrrolidone, methylcellulose, hydroxypropy lmethylcellulose, gelatin, polyethylene oxide, acrylic polymer, polyesters, polyurethanes, and a cross-linking

32. The ink-jet recording medium of claim 29, wherein the back coating layer has a thickness of between 0.5 to 4 μm.

33. The ink-jet recording medium of claim 1, further comprising a back coating layer formed on a surface of the substrate opposite the surface coated with the ink receiving layer.

34. The ink-jet recording medium of claim 1, wherein the ink receiving layer includes an additive pigment.

35. The ink-jet recording medium of claim 34, wherein the pigment is an inorganic pigment.

36. The ink-jet recording medium of claim 35, wherein the inorganic pigment is at least one of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, and silica.

37. The ink-jet recording medium of claim 34, wherein the pigment is an organic pigment.

38. The ink-jet recording medium of claim 37, wherein the organic pigment is at least one of a plastic pigment and an urea resin pigment.

39. The ink-jet recording medium of claim 34, wherein the additive pigment is one of 20 parts and less than 20 parts by weight.

40. The ink jet recording medium of claim 39, wherein the additive pigment is 0.0001-15 parts by weight.

41. The ink-jet recording medium of claim 1, wherein the polyvinyl alcohol has the degree of polymerization of at least 1,000.

42. The ink-jet recording medium of claim 41, wherein the polyvinyl alcohol has the degree of polymerization of between 1,500 to 5,000,

43. The ink-jet recording medium of claim 41, wherein the polyvinyl alcohol has a degree of saponification of between 70 and 100%.

44. The ink-jet recording medium of claim 43, wherein the polyvinyl alcohol has a degree of saponification of between 80 and 99.5%.

45. The ink-jet recoding medium of claim 1, wherein the ink receiving layer includes a hydrophilic polymer.

46. The ink-jet recoding medium of claim 45, wherein the hydrophilic polymer is one of a polyvinyl pyrrolidone, methylcellulose, hydroxypropyl methylcellulose, gelatin, starch, polyethylene oxide, acrylic polymer, polyester, and polyurethane.

47. The ink-jet recoding medium of claim 45, wherein the hydrophilic polymer is one of 50 parts and less than 50 parts by weight

48. The ink-jet recoding medium of claim 47, wherein the hydrophilic polymer is 0 to 20 parts by weight.

49. The ink-jet recording medium of claim 1, wherein at least one of the glass transition temperature (Tg), gel content, molecular weight, and the content of cationic functional groups of the cores and shells of the cationic core-shell latex differ.

50. A method of improving moisture resistance of an ink-jet recording medium, comprising:
coating a surface of a substrate with an ink receiving layer including an inorganic filler, a polyvinyl alcohol, a cationic core-shell latex with a glass transition temperature (Tg) of at least 50° C., and a zirconium compound.

51. A method of improving moisture resistance of an ink-jet recording medium, comprising:
forming an ink receiving layer including an inorganic filler, a polyvinyl alcohol, a cationic core-shell latex with a glass transition temperature (Tg) of at least 50° C., and a zirconium compound; and
coating a surface of a substrate with the ink receiving layer.
